(19) United States
(12) Patent Application Publication
(10) Pub. No.: US 2023/0134540 A1
(43) Pub. Date: May 4, 2023

(54) ELECTRIC TRANSPORTER DEVICE AND METHOD OF ASSEMBLING SAME

(71) Applicant: LG Electronics Inc., Seoul (KR)

(72) Inventors: Dong Yoon KIM, Seoul (KR); Dong Geun LEE, Seoul (KR); Young Choon KIM, Seoul (KR)

(21) Appl. No.: 17/912,425

(22) PCT Filed: Feb. 10, 2021
(86) PCT No.: PCT/KR2021/001812

§ 371 Date: Sep. 16, 2022

(30) Foreign Application Priority Data
Mar. 16, 2020 (KR) 10-2020-0032296

(51) Int. Cl. B62J 43/13; B62K 19/24; B21C 23/14

(52) U.S. Cl. CPC B62J 43/13; B62K 19/24; B21C 23/14; B62K 2202/00

(57) ABSTRACT

An electric mobility apparatus is disclosed. The electric mobility apparatus may include a steering assembly including a handlebar manipulated by a user and a support shaft having one side coupled to the handlebar, a mid-frame assembly including a user boarding part formed on an upper end, a front frame assembly having one side coupled to the support shaft and the other side on which a first connector having at least a portion fastened to one side of the mid-frame assembly is formed, and a tail frame assembly including a second connector of which at least a portion is fastened to the other side of the mid-frame assembly.

### TECHNICAL FIELD

Example embodiments of the present disclosure relate to an electric mobility apparatus and a method of assembling a same and relate to an electric mobility apparatus including a body frame formed by assembling a front frame assembly, a mid-frame assembly, and a tail frame assembly, which are not formed integrally.

### BACKGROUND ART

Recently, an electric mobility apparatus using electricity has been widely used for individuals moving in downtown areas. In general, the electric mobility apparatus may include a two-wheeled vehicle such as an electric bicycle, an electric scooter, and the like. The electric mobility apparatus may drive a motor using a built-in battery so that a user conveniently moves using the electric mobility apparatus.

KR 10-2019-0069807A relates to technology for improving safety in driving by reducing vibrations generated by a link member connecting a board assembly and a rear wheel portion. KR 10-1830161B1 relates to a footrest of an electric scooter that distributes a force, reinforces a strength, and stably accommodates a battery and a controller. KR 10-2017-0142006A relates to an electric scooter for achieving a stable balance by distributing and arranging a battery pack and various components including a link member in a board body. Such related documentations disclose a configuration using a separate link member, a configuration of a footrest including components therein, and a configuration to be folded but do not disclose a configuration for protecting internal components and improving convenience and strength of assembly as described herein.

### DISCLOSURE OF INVENTION

### Technical Goals

Example embodiments of the present disclosure are proposed to solve the above issues and disclose technology to form a body frame of an electric mobility apparatus by assembling a front frame assembly, a mid-frame assembly, and a tail frame assembly, which are not formed integrally. At this time, manufacturing methods and materials corresponding to the front frame assembly, the mid-frame assembly, and the tail frame assembly may be used to achieve increased efficiency in terms of costs and weight when compared to a body frame manufactured as a single body. In addition, an electric mobility apparatus having a structure for minimizing welding between a front frame assembly, a mid-frame assembly, and a tail frame assembly and fastening them through fastening grooves is provided. At this time, the fastening grooves are fastened using waterproof screws so that internal components are protected. Technical goals of the present disclosure are not limited as mentioned above and, although not mentioned, may include goals that can be clearly understood by those skilled in the art to which the present disclosure pertains, from the following description.

### Technical Solutions

When an electric mobility apparatus is formed as an integral body, there may be difficulty in cost and manufacturing convenience. To improve the manufacturing convenience, a body frame of an electric mobility apparatus may be manufactured by assembling a front frame assembly, a mid-frame assembly, and a tail frame assembly, which are not formed integrally. In this case, it is required to manufacture an electric mobility apparatus to achieve increased efficiency in terms of cost and weight while reinforcing a fastening force by assembling.

To achieve the above-described goals, an electric mobility apparatus according to an example embodiment of the present disclosure includes a steering assembly including a handlebar manipulated by a user and a support shaft having one side coupled to the handlebar, a mid-frame assembly including a user boarding part formed on an upper end, a front frame assembly having one side coupled to the support shaft and the other side on which a first connector having at least a portion fastened to one side of the mid-frame assembly is formed, and a tail frame assembly including a second connector of which at least a portion is fastened to the other side of the mid-frame assembly.

The tail frame assembly may include a tail frame and a rear wheel frame. The rear wheel frame may include two wheel arms formed to face each other, a first cut portion formed by cutting the wheel arm to seat a rear wheel shaft therein, a bridge configured to connect the two wheel arms, and an extension fastener formed to extend toward the other side of the wheel arm and inserted into the mid-frame assembly.

The tail frame assembly may include a tail frame and a rear wheel frame, the tail frame may include at least one slit formed on an outer side of the second connector, and an extension fastener of the rear wheel frame may be inserted into the mid-frame assembly by passing through the slit.

The tail frame assembly may include a tail frame and a rear wheel frame. The tail frame may include a planar portion configured to form a plane extending from a face formed on the upper end of the mid-frame assembly when coupled to the mid-frame assembly, a bent portion formed to extend from the planar portion and bent in an upper-end direction, and a sealing groove formed on the second connector.

The mid-frame assembly may include a guide on both inner side faces in a longitudinal direction of the mid-frame assembly, the guide forming an insertion passage through which an extension fastener of the tail frame assembly is to be inserted.

The mid-frame assembly may further include at least one fastening groove formed on the guide to fasten the extension fastener.

The mid-frame assembly may further include a hole formed on at least one side face and a fastening groove formed on the guide to fasten a support stand at a position corresponding to the hole.

The tail frame assembly may include a tail frame and a rear wheel frame, and the tail frame may further include a side-face guide configured to externally cover at least a portion of each of two wheel arms formed in the rear wheel frame.

At least one of a battery and an inverter may be mounted in the mid-frame assembly, and the battery and the inverter may be spaced apart from each other.

At least one fastening groove configured to fasten the first connector and the second connector may be formed on at least one of the upper end and a lower end of the mid-frame assembly.

The front frame assembly further may include a planar portion configured to form a plane extending from a face formed on the upper end of the mid-frame assembly when coupled to the mid-frame assembly, a bent portion formed to extend from the planar portion and bent toward the handlebar, and a fastener formed to extend from the bent portion and fastened to the steering assembly. An angle between the fastener and an upper end of the first connector may be 90 degrees (°) or more.

The front frame assembly may further include a sealing groove formed on a side opposite to a side in which the first connector is inserted into the mid-frame assembly.

The front frame assembly may be formed using a die casting method.

The mid-frame assembly may be formed using an extrusion method.

The tail frame assembly may include a tail frame formed using a plastic injection method and a rear wheel frame formed using a pressing method.

The front frame assembly and the mid-frame assembly may be formed of a metal material, the tail frame assembly may include a tail frame and a rear wheel frame, the tail frame may be formed of a plastic material, and the rear wheel frame may be formed of a steel material.

To achieve the above-described goals, an electric mobility apparatus according to another example embodiment of the present disclosure includes a handlebar manipulated by a user, a display coupled to the handlebar and configured to display information associated with the electric mobility apparatus, a front wheel, a rear wheel, a support shaft having one side coupled to the display and the other side coupled to the front wheel, a front frame assembly to which the support shaft is fastened with penetrating, a mid-frame assembly having at least a portion fastened to a first connector of the front frame assembly, and a tail frame assembly coupled to the rear wheel and including a second connector having at least a portion fastened to the other side of the mid-frame assembly.

The tail frame assembly may include a tail frame and a rear wheel frame. The rear wheel frame may include two wheel arms formed to face each other, a first cut portion formed by cutting the wheel arm to seat a rear wheel shaft therein, a bridge configured to connect the two wheel arms, and an extension fastener formed to extend toward the other side of the wheel arm and inserted into the mid-frame assembly.

The tail frame assembly may include a tail frame and a rear wheel frame, the tail frame may include at least one slit formed outward a face on which the second connector protrudes, and an extension fastener of the rear wheel frame may be inserted into the mid-frame assembly by passing through the slit.

The tail frame assembly may include a tail frame and a rear wheel frame. The tail frame may include a planar portion configured to form a plane extending from a face formed on the upper end of the mid-frame assembly when coupled to the mid-frame assembly, a bent portion formed to extend from the planar portion and bent in an upper-end direction, and a sealing groove formed on the second connector.

The mid-frame assembly may include a guide on both inner side faces in a longitudinal direction of the mid-frame assembly, the guide forming an insertion passage through which an extension fastener of the tail frame assembly is to be inserted. A length to which the extension fastener is inserted into the mid-frame assembly is at least twice as compared to the second connector.

The mid-frame assembly may further include at least one fastening groove formed on the guide to fasten the extension fastener.

The mid-frame assembly may further include a hole formed on at least one side face and a fastening groove formed on the guide to fasten a support stand at a position corresponding to the hole.

The tail frame assembly may include a tail frame and a rear wheel frame, and the tail frame may further include a side-face guide configured to externally cover at least a portion of each of two wheel arms formed in the rear wheel frame.

At least one of a battery and an inverter may be mounted in the mid-frame assembly, and the battery and the inverter may be spaced apart from each other.

At least one fastening groove configured to fasten the first connector and the second connector may be formed on at least one of the upper end and a lower end of the mid-frame assembly.

The front frame assembly further may include a planar portion configured to form a plane extending from a face formed on the upper end of the mid-frame assembly when coupled to the mid-frame assembly, a bent portion formed to extend from the planar portion and bent toward the handlebar, and a fastener formed to extend from the bent portion and fastened to the steering assembly. An angle between the fastener and an upper end of the first connector may be 90° or more.

The front frame assembly may further include a sealing groove formed on a side opposite to a side in which the first connector is inserted into the mid-frame assembly.

The front frame assembly may be formed using a die casting method.

The mid-frame assembly may be formed using an extrusion method.

The tail frame assembly may include a tail frame formed using a plastic injection method and a rear wheel frame formed using a pressing method.

The front frame assembly and the mid-frame assembly may be formed of a metal material, the tail frame assembly may include a tail frame and a rear wheel frame, the tail frame may be formed of a plastic material, and the rear wheel frame may be formed of a steel material.

To achieve the above-described goals, a method of assembling a body frame of an electric mobility apparatus according to another example embodiment of the present disclosure includes fastening a front frame assembly to a mid-frame assembly by inserting at least a portion of the front frame assembly into a front face of the mid-frame assembly, fastening a rear wheel frame to pass through at least one slit formed on a tail frame, and inserting at least a portion of the tail frame and at least a portion of the rear wheel frame into a rear face of the mid-frame assembly so as to be fastened thereto. At least a portion of the tail frame is inserted into a space formed between two guides that are formed on both inner side faces of the mid-frame assembly and spaced apart from each other. At least a portion of the rear wheel frame is inserted into a space formed between the guides formed at positions corresponding to both inner side faces of the mid-frame assembly.

Details of other example embodiments are included in the detailed descriptions and drawings.

### Effects

According to example embodiments of the present disclosure, one or more of the following effects can be achieved.

First, due to limitations such as costs and weight of a mold, it is difficult to manufacture a body frame of an electric mobility apparatus as a single body using one manufacturing method. To avoid this, it is possible to form a body frame by dividing the body frame into a front frame assembly, a mid-frame assembly, and a tail frame assembly and assembling the same. At this time, manufacturing methods and materials corresponding to the front frame assembly, the mid-frame assembly, and the tail frame assembly may be used to manufacture an electric mobility apparatus with increased efficiency in terms of costs and weight.

Further, it is possible to provide an electric mobility apparatus having a structure for minimizing welding between a front frame assembly, a mid-frame assembly, and a tail frame assembly and fastening them through fastening grooves.

Further, it is possible to protect components in a body frame by using a waterproof screw for fastening to a fastening groove. In addition, it is possible to protect the components in the body frame by sealing gaps between a front frame assembly, a mid-frame assembly, and a tail frame assembly using a rubber material.

Further, it is possible to form a body frame, which is safe from a shock generated during driving of electric mobility apparatus using manufacturing methods and materials corresponding to a front frame assembly, a mid-frame assembly, and a tail frame assembly.

Effects are not limited to the aforementioned effects, and other effects not mentioned will be clearly understood by those skilled in the art from the description of the claims.

### BRIEF DESCRIPTION OF DRAWINGS

FIG. 1 is a perspective view illustrating an electronic mobility apparatus according to an example embodiment.

FIG. 2 is a side view illustrating an electric mobility apparatus according to an example embodiment.

FIG. 3A is a perspective view illustrating a body frame according to an example embodiment. FIG. 3B is an exploded side view illustrating a body frame according to an example embodiment.

FIG. 4A is a front view illustrating a front frame assembly according to an example embodiment, FIG. 4B is a right-side view illustrating a front frame assembly according to an example embodiment, FIG. 4C is a rear view illustrating a front frame assembly according to an example embodiment, and FIG. 4D is a perspective view illustrating a front frame assembly according to an example embodiment.

FIG. 5A is a perspective view illustrating a mid-frame assembly decoupled from a support stand according to an example embodiment and FIG. 5B is a right-side view illustrating a mid-frame assembly coupled to a support stand according to an example embodiment.

FIG. 6A is a right-side view illustrating a tail frame assembly according to an example embodiment, FIG. 6B is a rear view illustrating a tail frame assembly according to an example embodiment, and FIG. 6C is a perspective view illustrating a tail frame assembly according to an example embodiment.

FIG. 7A is a plan view illustrating a tail frame according to an example embodiment, FIG. 7B is a perspective view illustrating a tail frame according to an example embodiment, FIG. 7C is a front view illustrating a tail frame according to an example embodiment, and FIG. 7D is a rear view illustrating a tail frame according to an example embodiment.

FIG. 8A is a perspective view illustrating a rear wheel frame according to an example embodiment, FIG. 8B is a plan view illustrating a rear wheel frame according to an example embodiment, and FIG. 8C is a right-side view illustrating a rear wheel frame according to an example embodiment.

FIG. 9A is a front perspective view illustrating a tail frame assembly coupled with a rear wheel according to an example embodiment and FIG. 9B is a rear perspective view illustrating a tail frame assembly decoupled from a rear wheel according to an example embodiment.

### BEST MODE FOR CARRYING OUT THE INVENTION

Hereinafter, example embodiments of the present disclosure will be described in detail with reference to the accompanying drawings.

The same or similar components may be given the same reference numerals regardless of the reference numerals, and redundant description thereof may be omitted. With respect to constituent elements used in the following description, suffixes “module” and “unit” are given or mingled with each other only in consideration of ease in the preparation of the specification, and do not have or serve as different meanings. Also, in the description of embodiments, detailed description of well-known arts will be omitted when it is deemed that such description will cause ambiguous interpretation of the present disclosure. In addition, the accompanying drawings are only for easy understanding of the embodiments disclosed in the present specification, and the technical ideas disclosed in the present specification are not limited by the accompanying drawings. Also, it should be understood to cover all modifications, equivalents, and alternatives falling within the spirit and scope of the present specification.

Although terms such as “first” and “second” may be used herein to describe various elements, these elements are not to be limited by these terms. Rather, these terms are only used to distinguish one element from another element.

When an element is described as being “connected to” or “coupled to” another element, it may be directly “connected to” or “coupled to” the other element, or there may be other elements intervening therebetween. in contrast, when an element is described as being “directly connected” or “directly coupled to” another element, there can be no other elements intervening therebetween.

The singular forms are intended to include the plural forms as well, unless the context clearly indicates otherwise.

In the present specification, it will be further understood that the terms “comprises” or “includes”, when used herein, specify the presence of stated features, integers, steps, operations, elements, components, or combinations thereof, but do not preclude the presence or addition of one or more other features, integers, steps, operations, elements, components, or combinations thereof.

In describing the example embodiments, descriptions of technical contents that are well known in the art to which the present disclosure belongs and are not directly related to the present specification will be omitted. This is to more clearly communicate without obscuring the subject matter of the present specification by omitting unnecessary description.

For the same reason, in the accompanying drawings, some components are exaggerated, omitted or schematically illustrated. In addition, the size of each component does not fully reflect the actual size. The same or corresponding components in each drawing are given the same reference numerals.

Advantages and features of the present disclosure and methods of achieving them will be apparent from the following example embodiments that will be described in more detail with reference to the accompanying drawings. It should be noted, however, that the present disclosure is not limited to the following example embodiments, and may be implemented in various forms. Accordingly, the example embodiments are provided only to disclose the present disclosure and let those skilled in the art know the category of the present disclosure. In the drawings, embodiments of the present disclosure are not limited to the specific examples provided herein and are exaggerated for clarity. The same reference numerals or the same reference designators denote the same elements throughout the specification.

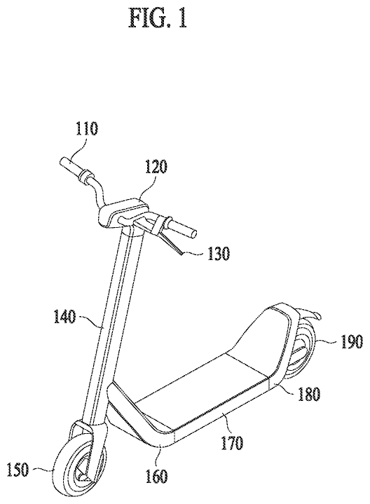

FIG. 1 is a perspective view illustrating an electronic mobility apparatus according to an example embodiment.

FIG. 1 illustrates components included in an electric mobility apparatus.

An electric mobility apparatus may include at least one of a handlebar 110, a display 120, a brake lever 130, a support shall 140, a front wheel 150, a front frame assembly 160, a mid-frame assembly 170, a tail frame assembly 180, and a rear wheel 190.

The handlebar 110 may be manipulated by a user so that a direction of the electric mobility apparatus is changed. In addition, an acceleration input may be received based on the handlebar 110 manipulated by the user. Based on the acceleration input, a speed of the electric mobility apparatus may be adjusted. For example, when the user pulls or rotates the handlebar 110 in a predetermined direction, the electric mobility apparatus may be accelerated, and the user may move the handlebar 110 to change the direction of the electric mobility apparatus.

The display 120 may display information associated with the electric mobility apparatus. For example, the display 120 may display various information such as a current speed, an amount of charge remaining in a battery, whether the user is authenticated, a vehicle status, a speed limitation, power on/off, communication module-related operation information, accelerating torque-related information, decelerating torque-related information, braking charging-related information, and the like of the electric mobility apparatus,

The handlebar 110 and the display 120 may be coupled to the support shaft 140. In addition, the support shaft 140 may be coupled to the front wheel 150 and the front frame assembly 160. At this time, the support shaft 140 may be fastened to the front frame assembly 160 by penetrating the front frame assembly 160.

A communication module to be mounted in the electric mobility apparatus may transmit and receive data to and from external devices using wired or wireless communication. The communication module may employ communication technologies such as a global system for mobile communication (GSM), code division multi access (CDMA), long-term evolution (LTE), fifth generation (5G), wireless LAN (WLAN), wireless-fidelity (Wi-Fi), Bluetooth™, radio frequency identification (RFID), Infrared Data Association (IrDA), ZigBee, near field communication (NFC), and the like. The electric mobility apparatus may use the communication module to perform communication with at least one of another electric mobility apparatus, a mobile terminal, a base station, an access point (AP), and infrastructure.

In response to the brake lever 130 being manipulated by the user, the speed of the electric mobility apparatus may be reduced. The brake lever 130 may be connected to at least one of both side handlebars. For example, in response to the brake lever 130 being manipulated, a mechanical braking force may be applied to at least one of the front wheel 150 and the rear wheel 190. According to an example embodiment, the user may control the brake lever 130 to cause mechanical braking so that the speed of the electric mobility apparatus may be reduced. As an example, based on the manipulation of the brake lever 130, a portion of the front wheel 150 may contact a brake pad, so that the braking force is generated by friction.

The front wheel 150 mechanically braked by the brake lever 130 is merely an example, and the rear wheel 190 may be braked by the brake lever 130. As another example, in response to the brake lever 130 being manipulated, an electrical braking force may be applied to at least one of the front wheel 150 and the rear wheel 190. When a motor connected to at least one of the front wheel 150 and the rear wheel 190 rotates, controlling an inverter to brake the rotation of the motor may be electrical braking. The electrical braking may include at least one of regenerative braking for charging a battery with electrical energy generated based on the inverter control, power generation braking that converts the generated electrical energy into heat energy and consumes the same, and redundant braking that turns off all switches of the inverter. According to an example embodiment, in response to the manipulation of the brake lever 130, the mechanical braking for the front wheel 150 and the electrical braking for the rear wheel 190 may be applied together.

A movement of the front wheel 150 may be determined based on the handlebar 110 manipulated by the user. In addition, a rotational speed of the front wheel 150 may be reduced through mechanical braking by the brake lever 130.

Since the rear wheel 190 receives power from the motor connected to the inverter, the speed of the rear wheel 190 may be increased by the motor. In addition, the rotational speed of the rear wheel 109 may be reduced by electrical braking. The speed of the electric mobility apparatus may be reduced through the reduction of the rotational speed of the front wheel 107 or the rear wheel 109. Here, the motor may be a brushless direct current motor (BLDC), an induction motor, or a reluctance motor or include a driving and regenerative braking type electric motor (for example, both a motor and a generator).

A body frame may serve as a support plane related to the user getting on a vehicle. Components (for example, a battery, a controller, an inverter, and the like) may be mounted in the body frame so that the mounted components are protected from external shock. The body frame may be formed by coupling with at least one of the front frame assembly 160, the mid-frame assembly 170, and the tail frame assembly 180.

One side of the front frame assembly 160 may be coupled to the support shaft 140. The other side of the front frame assembly 160 may be partially inserted into a front face of the mid-frame assembly 170. An upper end of the mid-frame assembly 170 may be a boarding part on which the user is to be located and serve as the support plane. A portion of the tail frame assembly 180 may be inserted into a rear face of the mid-frame assembly 170. The front frame assembly 160, the mid-frame assembly 170, and the tail frame assembly 180 will be described in detail later.

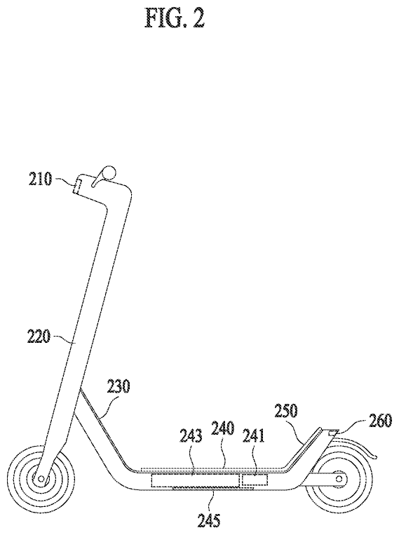

FIG. 2 is a side view illustrating an electric mobility apparatus according to an example embodiment.

FIG. 2 illustrates components mounted or attached to an electric mobility apparatus.

A front lamp 210 may emit light illuminating an area in front of the electric mobility apparatus during driving. In addition, a rear lamp 260 may emit light illuminating an area behind the electric mobility apparatus during driving. Also, according to an example embodiment, a bottom lamp 245 attached to a bottom of the body frame may be included. The bottom lamp 245 may emit light to a road on which the electric mobility apparatus travels. At least one of the front lamp 210, the rear lamp 260, and the bottom lamp 245 may be connected to a battery to receive power.

A support shaft 220 may be coupled to a front frame assembly 230. At this time, an electric wire connecting the battery and the front lamp 210 may pass through the support shaft 220. In addition, electric wires related to a display, a handlebar, and a communication module may pass through the support shaft 220.

A portion of the front frame assembly 230 may be inserted into a front face of a mid-frame assembly 240. A portion of a tail frame assembly 250 may be inserted into a rear face of the mid-frame assembly 240. The mid-frame assembly 240 may include components (for example, a battery, an inverter, a controller, and the like) therein. For example, an inverter 241 and a battery housing 243 may be included in the mid-frame assembly 240.

The inverter 241 may control a rotation of a motor based on a control of a controller. The battery housing 243 may include a battery and a battery management system (BMS) and protect the internal battery and BMS from external shock. The battery may include a plurality of battery cells and include a rechargeable battery pack. The battery may supply power to components such as the motor, the controller, the inverter, the communication module, the front lamp, the rear lamp, and the like.

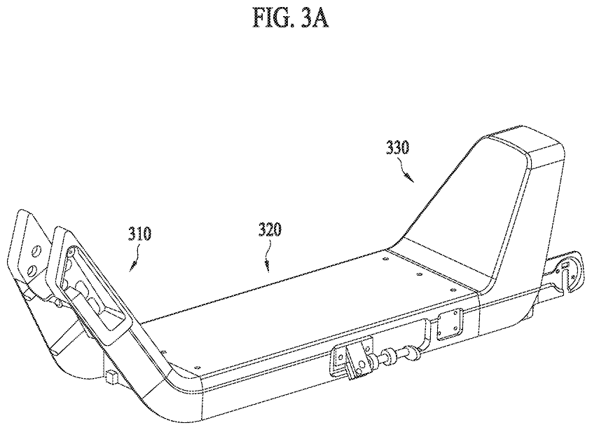

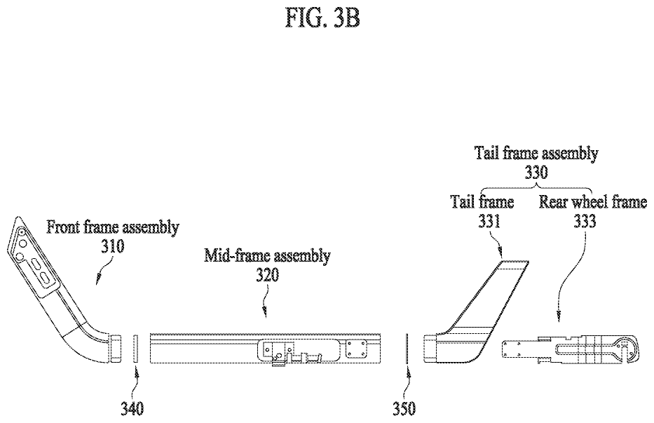

FIG. 3A is a perspective view illustrating a body frame according to an example embodiment and FIG. 3B is an exploded side view illustrating a body frame according to an example embodiment.

Referring to FIGS. 3A and 3B, a body frame may include at least one of a front frame assembly 310, a mid-frame assembly 320, and a tail frame assembly 330. At this time, a sealing member 340 may be provided between the front frame assembly 310 and the mid-frame assembly 320 to seal a gap therebetween. Through such sealing, a waterproofing effect may be achieved to prevent water from entering the mid-frame assembly. In addition, a sealing member 350 may be provided between the mid-frame assembly 320 and the tail frame assembly 330 to seal a gap therebetween. Likewise, through such sealing, the waterproofing effect may be achieved to prevent water from entering the mid-frame assembly. The sealing members 340 and 350 may prevent water from entering the frame so that the components in the body frame may be protected. In addition, by coupling the frames using the sealing members 340 and 350, noise generated between the frames may be reduced even when a force is applied to the electric mobility apparatus. In the example embodiment, the sealing member may be formed of an elastic material, for example, rubber.

One side of the front frame assembly 310 may be coupled to a support shaft. The other side of the front frame assembly 310 may be partially inserted into a front face of the mid-frame assembly 320. A portion of the tail frame assembly 330 may be inserted into a rear face of the mid-frame assembly 320. Accordingly, the body frame of the electric mobility apparatus may be formed by coupling the front frame assembly 310, the mid-frame assembly 320, and the tail frame assembly 330. The tail frame assembly 330 may include a tail frame 331 and a rear wheel frame 333. The rear wheel frame may pass through a slit of the tail frame to be inserted into the mid-frame assembly 320.

The front frame assembly 310, the mid-frame assembly 320, and the tail frame assembly 330 will be described in detail later.

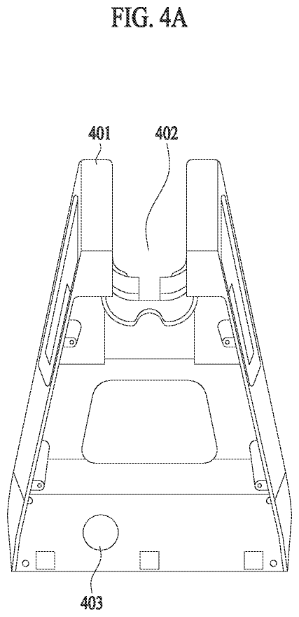

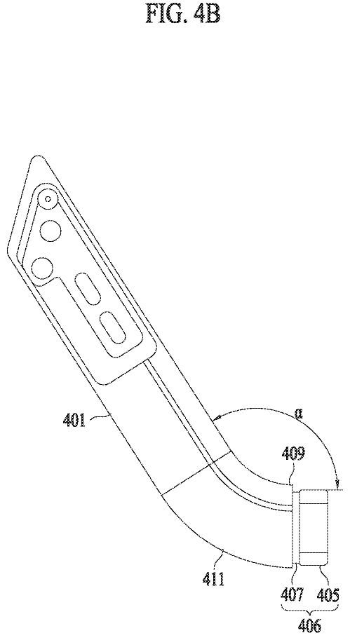

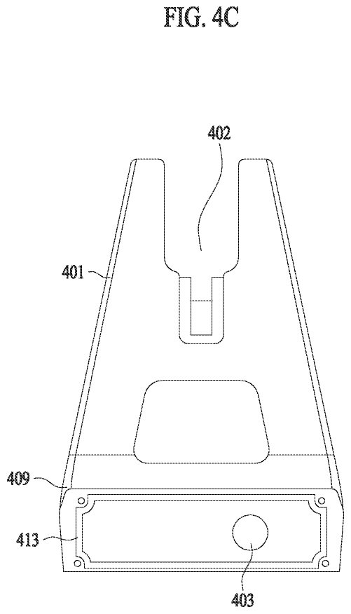

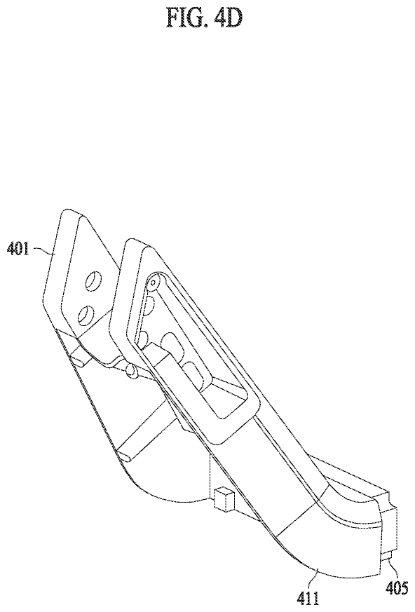

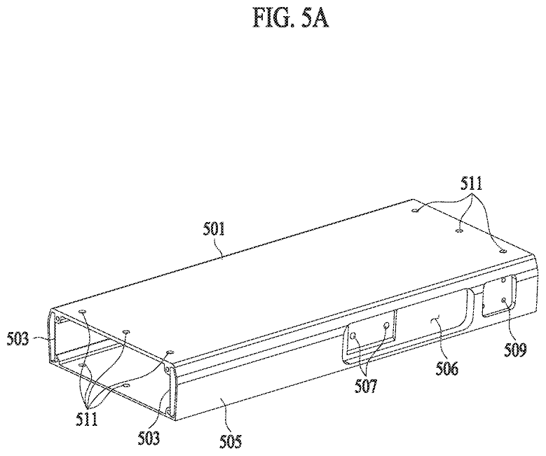

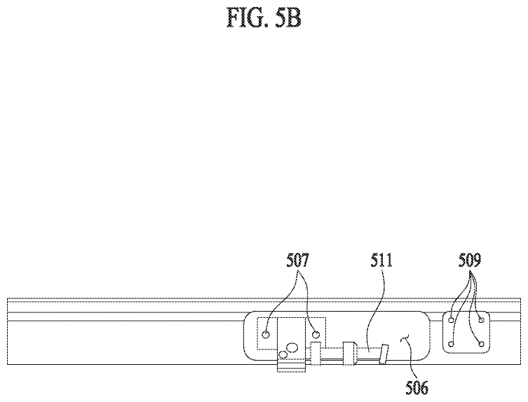

FIG. 4A is a front view illustrating a front frame assembly according to an example embodiment, FIG. 4B is a right-side view illustrating a front frame assembly according to an example embodiment, FIG. 4C is a rear view illustrating a front frame assembly according to an example embodiment, and FIG. 4D is a perspective view illustrating a front frame assembly according to an example embodiment.

Referring to FIGS. 4A and 4D, a front frame assembly may include a fastener 401 fastened to a steering assembly including a support shaft. The fastener 401 may include a groove 402 that the steering assembly passes through and seats therein. A shape of the groove may correspond to a shape of the steering assembly. The front frame assembly may include a hole 403 through which an electric wire passes. Electric wires connected to components (for example, a battery, an inverter, a controller, and the like) included in the mid-frame assembly may pass through the hole 403 to be connected to other components (for example, a display and a handlebar) of the electric mobility apparatus through the support shaft.

The front frame assembly may include at least one of the fastener 401, a bent portion 411, a planar portion 409, and a first connector 406. The first connector 406 may be inserted into a front face of the mid-frame assembly to be fastened to the mid-frame assembly. At this time, the first connector 406 may include a sealing groove 407 and a planar portion 405. A sealing member may be seated in the sealing groove 407. At this time, the planar portion 405 may be inserted into the front face of the mid-frame assembly, and the sealing member seated in the sealing groove 407 may be compressed when the mid-frame assembly is fastened to the front frame assembly. By inserting and fastening the first connector 406 to the front face of the mid-frame assembly, the front frame assembly may be more firmly coupled with the mid-frame assembly. Specifically, as the first connector 406 is inserted into the front face of the mid-frame assembly, a generated moment may be dispersed, which may lead to a more strong engagement. The first connector may be inserted into the mid-frame assembly such that a component (for example, the battery) included in the mid-frame assembly is spaced apart from the first connector at a predetermined distance.

A sealing member 413 may be seated in the sealing groove 407. Due to the waterproof effect achieved by the sealing member 413, components in the mid-frame assembly may be protected. At this time, the sealing groove 407 may be formed to a side opposite to a side at which the first connector 406 is inserted into the mid-frame assembly. In addition, the sealing groove 407 may be disposed between the planar portion 409 and the planar portion 405 so that the sealing member is seated at an end of a direction opposite to a direction in which the first connector 406 is inserted into the mid-frame assembly.

When coupled to the mid-frame assembly, the planar portion 409 may form a plane extending from an upper end of the mid-frame assembly. The bent portion 411 may extend from the planar portion 409 and be bent in a handlebar direction. One side of the bent portion 411 may be in contact with the planar portion 409. The other side of the bent portion 411 may be in contact with the fastener 401. At this time, an angle a between the fastener 401 and the planar portion 409 obtained by the bent portion 411 may be 90 degrees (°) or more. Specifically, the angle a between the fastener 401 and the first connector 405 obtained by the bent portion 411 may be ranged between 90° and 150°, inclusive.

The sealing member 413 may be seated in the sealing groove 407. At this time, a shape of the sealing member 413 may correspond to a shape of the first connector 406.

According to an example embodiment, the front frame assembly may be formed using a die-casting method. At this time, the front frame assembly may be formed of a lightweight metal material, For example, the front frame assembly may be formed based on a die-casting method using aluminum. Through this, the material cost may be reduced, and a strength may be reinforced while reducing the weight of the electric mobility apparatus.

FIG. 5A is a perspective view illustrating a mid-frame assembly decoupled from a support stand according to an example embodiment and FIG. 5B is a right-side view illustrating a mid-frame assembly coupled to a support stand according to an example embodiment.

FIGS. 5A and 5B illustrate a mid-frame assembly and a support stand coupled therewith. The mid-frame assembly may form a user boarding part on an upper end 501. For example, a cover may be disposed at the upper end 501 of the mid-frame assembly, so that a user gets on the cover.

The mid-frame assembly may include at least one fastening groove 511. The at least one fastening groove 511 may be formed in at least one of an upper end and a lower end of the mid-frame assembly to fasten a first connector and a second connector. Specifically, the fastening groove 511 may be used to fasten the upper end of the mid-frame assembly and a first connector of a front frame assembly or a second connector of a tail frame assembly. Alternatively, the fastening groove 511 may be used to fasten the lower end of the mid-frame assembly and the first connector of the front frame assembly or the second connector of the tail frame assembly. In the example embodiment, the first connector and the second connector may have grooves corresponding to the fastening groove 511 when inserted into the mid-frame assembly so that a fastening member is inserted through the fastening grooves and then coupled to the mid-frame assembly. In the overall example embodiment, coupling through the fastening groove may indicate that the fastening member is inserted through the fastening groove so that at least one element is coupled to another element. In the example embodiment, the fastening member may include a screw, a nail, a rivet, and the like, and may include any fastening member generally used in the fastening groove.

A guide 503 may be formed on both inner side faces of the mid-frame assembly in a longitudinal direction of the mid-frame assembly. An insertion passage may be formed between the guide 503 and each of the inner side faces of the mid-frame assembly, and an extension fastener of the tail frame assembly may be inserted into the insertion passage. For example, the insertion passage to which the extension fastener is to be inserted may be formed between the guide 503 and one side face 505. At this time, a length to which the extension fastener is inserted into the mid-frame assembly may be at least twice when compared to the second connector. For example, a length to which the extension fastener is inserted into the mid-frame assembly may be at least twice a length to which the second connector is inserted into the mid-frame assembly.

The one side face 505 of the mid-frame assembly may have a hole 506 so that a portion of the guide 503 is exposed outside through the hole 506. A support stand 513 may be fastened at a position corresponding to the hole 506, and the support stand 513 may be fastened to the guide 503 using at least one fastening groove 507. Here, the support stand 513 may be bent toward a bottom of the mid-frame assembly by an external force when the electric mobility apparatus is stopped, thereby supporting the electric mobility apparatus. At this time, the fastening groove 507 may be formed on an outer side face of the guide 503. In addition, the fastening groove 507 may be fastened to the support stand 513, and simultaneously, fastened to a bracket mounted in the mid-frame assembly. As such, by fastening the support stand 513 and the bracket together through the fastening groove 507, it is possible to improve an assembly and durability of components coupled in the electric mobility apparatus.

A fastening groove 509 may be formed on at least one of the guide 503 and both side faces including the one side face 505 of the mid-frame assembly. Using the fastening groove 509, the extension fastener of the tail frame assembly and the mid-frame assembly may be fastened. Here, the number of the fastening grooves 507 and 509 and positions of the same shown in FIG. 5A are provided as merely an example, and the example is not to be taken as being limited thereto.

According to an example embodiment, the mid-frame assembly may be formed based on an extrusion method. The extrusion method may be relatively advantageous compared to a die casting method in terms of costs and strength. At this time, like the front frame assembly, the mid-frame assembly may be formed of a lightweight metal material. For example, the mid-frame assembly may be formed based on an extrusion method using aluminum. From this, the material cost may be reduced and the strength may be reinforced while reducing the weight of the electric mobility apparatus.

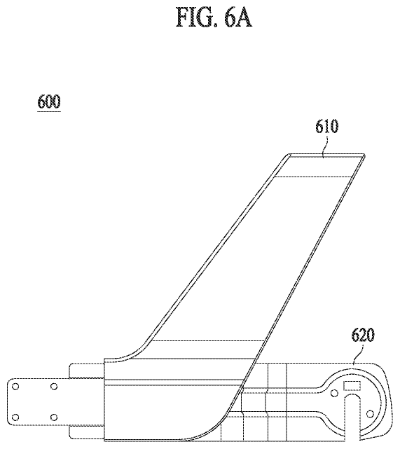

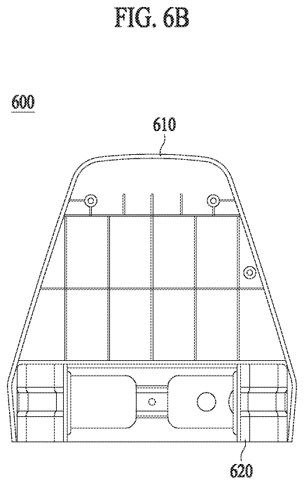

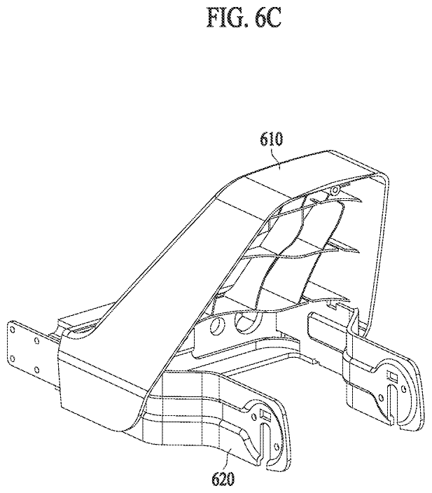

FIG. 6A is a right-side view illustrating a tail frame assembly according to an example embodiment, FIG. 6B is a rear view illustrating a tail frame assembly according to an example embodiment, and FIG. 6C is a perspective view illustrating a tail frame assembly according to an example embodiment.

FIGS. 6A through 6C illustrate a configuration of a tail frame assembly.

In the example embodiment, a tail frame assembly 600 may include a tail frame 610 and a rear wheel frame 620. At this time, the rear wheel frame 620 may pass through the tail frame 610 to be inserted into a mid-frame assembly. An extension fastener of the rear wheel frame 620 may be fastened to the mid-frame assembly. At least a portion of a second connector of the tail frame 610 may be inserted into a rear face of the mid-frame assembly. The tail frame 610 and the rear wheel frame 620 will be described in detail later.

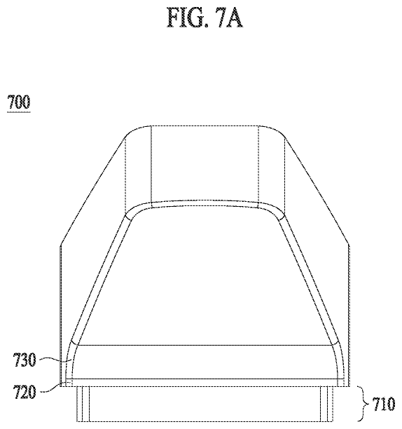

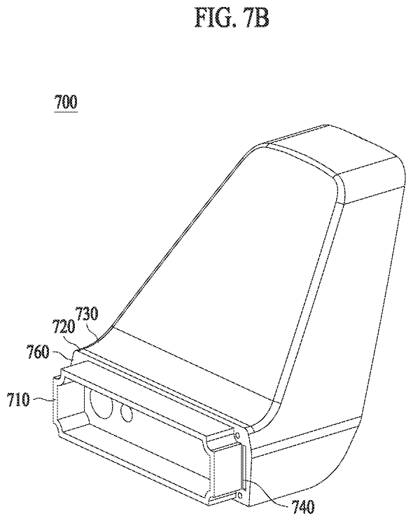

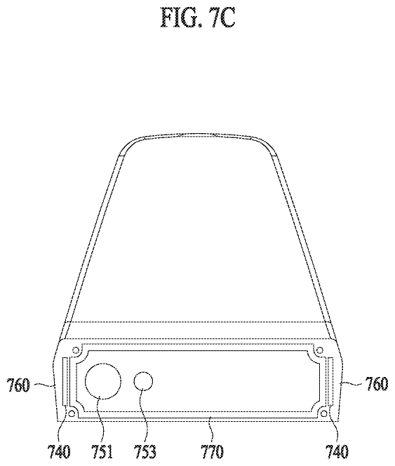

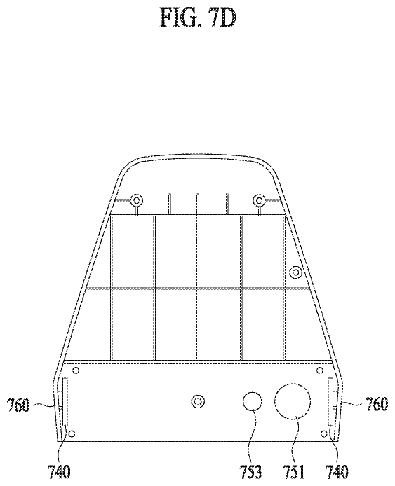

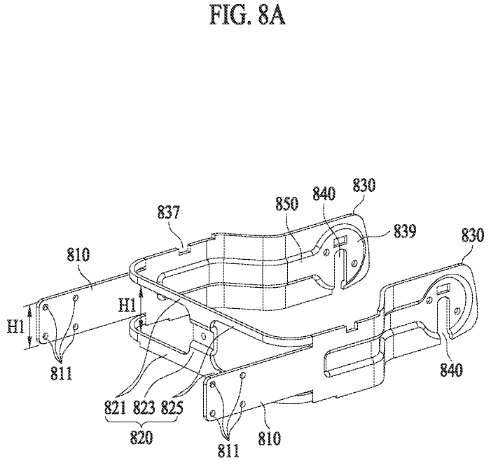

FIG. 7A is a plan view illustrating a tail frame according to an example embodiment, FIG. 7B is a perspective view illustrating a tail frame according to an example embodiment, FIG. 7C is a front view illustrating a tail frame according to an example embodiment, and FIG. 7D is a rear view illustrating a tail frame according to an example embodiment.

FIGS. 7A through 7D illustrate a configuration of a tail frame 700. The tail frame 700 may include a second connector 710 having at least a portion inserted into a rear face of a mid-frame assembly. When the second connector 710 is inserted into the rear face of the mid-frame assembly and fastened thereto, the tail frame assembly and the mid-frame assembly may be more firmly coupled to each other. Specifically, when the second connector 710 is inserted into the rear face of the mid-frame assembly, a moment generated by a force applied to the tail frame 700 may be distributed so that the tail frame assembly and the mid-frame assembly are more firmly coupled. The second connector may be inserted into the mid-frame assembly such that a component (for example, an inverter) included in the mid-frame assembly is spaced apart from the second connector at a predetermined distance. In addition, the bracket fastened to the component may be mounted in the mid-frame assembly.

A planar portion 720 may form a plane extending from an upper end of the mid-frame assembly when coupling to the mid-frame assembly. One side of a bent portion 730 may extend from the planar portion 720, and the other side may be bent in an upper-end direction. In addition, the tail frame 700 may extend from the bent portion 730 to be placed to cover one side of a rear wheel.

A tail frame may include at least one slit 740 formed on an outer side of a plane on which the second connector 710 protrudes. Specifically, the tail frame may include at least two slits 740 formed on both side faces of the second connector 710. An extension fastener of the rear wheel frame may pass through the slit 740 to be inserted into the mid-frame assembly.

The tail frame may include a through-hole 751, 753 through which an electric wire passes. Specifically, the electric wire may pass through the through-hole 751, 753 to connect a component mounted on the mid-frame assembly and a rear wheel. For example, to connect an inverter of the mid-frame assembly and a motor mounted on the rear wheel, the electric wire may pass through at least one through-hole 751, 753. In this example, a first through-hole 751 may have an area greater than that of a second through-hole 753. For example, the first through-hole 751 may have an area at least twice the area of the second through-hole 753. Electric wires passing through the first through-hole 751 and the second through-hole 753 may be connected to different electric loads fastened to a tail assembly. For example, the electric wire connecting the inverter and the motor mounted on the rear wheel may pass through the first through-hole, and the electric wire connecting the battery and a rear lamp may pass through the second through-hole. In the example embodiment, the rear lamp may be seated behind the tail frame.

In addition, the rear wheel frame may include two wheel arms. On both sides, the tail frame may include side-face guides 760 covering at least portions of the two wheel arms externally. The side-face guides 760 on both sides of the tail frame may be formed to externally cover at least portions of the two wheel arms of the rear wheel frame passing through the slit 740.

According to an example embodiment, the tail frame may be formed of a lightweight material to reduce product weight. Specifically, the tail frame may be formed using a plastic injection method, in which case a plastic material may be used. Through this, the material cost may be reduced and the weight of the electric mobility apparatus may be reduced.

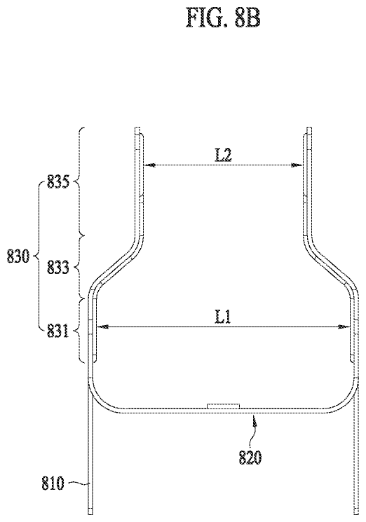

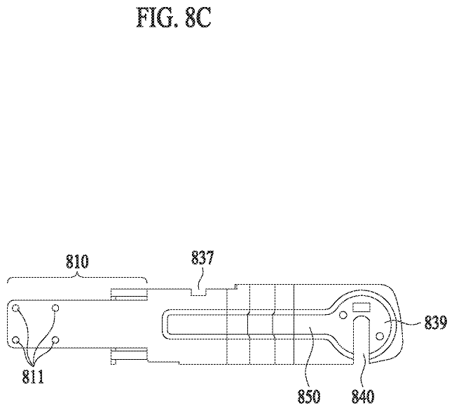

FIG. 8A is a perspective view illustrating a rear wheel frame according to an example embodiment, FIG. 8B is a plan view illustrating a rear wheel frame according to an example embodiment, and FIG. 8C is a left-side view illustrating a rear wheel frame according to an example embodiment.

Referring to FIGS. 8A through 8C, a rear wheel frame 800 may include at least one of two wheel arms 830, a first cut portion 840, a bridge 820, and an extension fastener 810.

The extension fastener 810 may be formed by cutting a portion of the bridge 820. Specifically, in the rear wheel frame 800, the extension fastener may be formed by cutting a portion of the bridge 820 and bending based on a position at which the extension fastener 800 is extended from and formed at the wheel arm 830. For example, the rear wheel frame 800 may be formed by bending a substantially flat iron plate. In addition, the rear wheel frame 800 may be formed in a manner of cutting a portion of the bridge 820 as shown in the drawing and then bending a position at which the extension fastener 800 is extended from and formed at the wheel arm 830.

The bridge 820 may include first bridges 821 connected to one end of one of the two wheel arms 830, second bridges 825 connected to one end of a remaining one of the two wheel arms, and a bridge connector 823. At this time, the bridge connector 823 may be spaced apart from the two wheel arms and connect the first bridges 821 and the second bridges 825. At this time, a distance H1 between the first bridges 821 may correspond to a width H1 of the extension fastener 810. Likewise, a distance between the second bridges 825 may correspond to a width of the extension fastener 810. Specifically, since the extension fastener 810 is formed by cutting a portion of the bridge 820, the width H1 of the extension fastener 810 may be equal to a distance separating the bridge 820.

The first cut portion 840 may be cut toward a lower end of the rear wheel frame 800. A rear wheel shaft coupled to a rear wheel may be seated in the first cut portion 840, and through this, may be coupled to the rear wheel frame 800. At this time, the rear wheel shaft and the rear wheel frame 800 may be formed on a metal material in consideration of the strength. Specifically, the rear wheel shaft and the rear wheel frame 800 may have the same strength or strengths similar within a predetermined range to support each other. For example, the rear wheel shaft and the rear wheel frame 800 may be formed of a material of galvanized iron.

The two wheel arms 830 may be formed to face each other. The first cut portion 840 in which the rear wheel shaft is seated may be cut and formed at the two wheel arms 830. The two wheel arms 830 may each include a wheel arm body 831 connected to the bridge 820, a bent portion 833, and a shaft connector 835 including the first cut portion 840. Here, the bent portion 833 may be located between the wheel arm body 831 and the shaft connector 835. In addition, the bent portion 833 may be bent such that a distance between the shaft connectors 835 of the two wheel arms 830 is less than a distance between the wheel arm bodies 831. Specifically, the bent portion 833 may be bent such that a distance L2 between the shaft connectors 835 is less than a distance L1 between the wheel arm bodies 831. Specifically, the distance L2 may be determined based on a size of the rear wheel. In addition, the distance L2 may be determined to be greater than or equal to a predetermined percentage of the distance L1 to distribute a moment by the rear wheel and the rear wheel shaft. For example, to distribute the moment, the distance L2 may be determined to be 75% of the distance L1 or more.

The rear wheel frame 800 may include the extension fastener 810 that is inserted into the mid-frame assembly by passing through a slit of a tail frame. The extension fastener 810 may include at least one fastening groove 811 fastened to a side face of the mid-frame assembly. The fastening groove 811 may be fastened to the fastening groove 509 formed on the side face of the mid-frame assembly.

The wheel arm 830 may include a second cut portion 837 in which a portion of the tail frame is seated on an upper end. When the rear wheel frame passes through the slit of the tail frame, the tail frame may be seated in the second cut portion 837, which may lead to an increase in bonding force. The second cut portion 837 may have a shape corresponding to a shape of the seated tail frame.

The wheel arm 830 may include a recess 839 formed around the first cut portion 840 in an inward direction. A washer connected to the rear wheel shaft may be seated in the recess 839. At this time, the recess 839 may be shaped to protrude toward an inner side of the wheel arm 830 to correspond to the washer.

A protrusion 850 may be formed to protrude toward the inner side of the wheel arm 830 throughout the wheel arm body 831, the bent portion 833, and the shaft connector 835, One end of the protrusion 8:50 may be connected to the recess 839. A strength of the rear wheel frame may be reinforced by the protrusion 850.

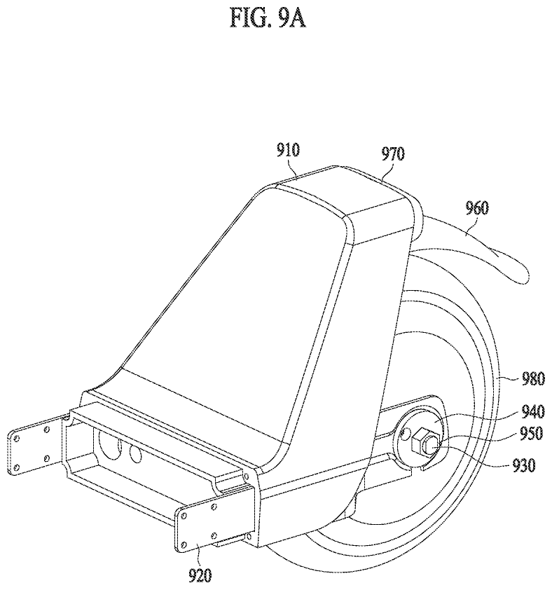

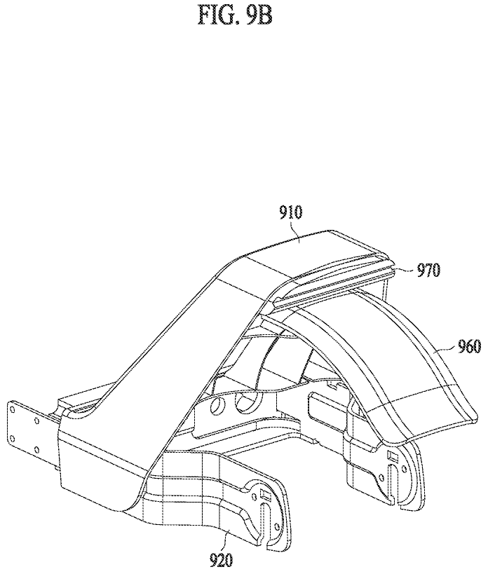

FIG. 9A is a front perspective view illustrating a tail frame assembly coupled with a rear wheel according to an example embodiment and FIG. 9B is a rear perspective view illustrating a tail frame assembly decoupled from a rear wheel according to an example embodiment.

Referring to FIGS. 9A and 9B, a tail frame assembly may include a tail frame 910 and a rear wheel frame 920. In addition, the rear wheel frame 920 may be coupled to a rear wheel shaft 930. At this time, a washer 940 and a bolt 950 may be used for fastening. The tail frame 910 may be fastened to a rear lamp 970 and a guard 960 for protecting a rear wheel 980. Here, the guard 960 may be an example of a fender assembly. The rear wheel shaft 930 passing through the rear wheel 980 may be seated and fastened to the rear wheel frame 92.0 so that the rear wheel 980 is coupled to the tail frame assembly.

The above description is merely illustrative of the technical idea of the present disclosure, and those skilled in the art to which the present disclosure pertains may make various modifications and changes without departing from the essential quality of the present disclosure. Accordingly, the example embodiments disclosed herein are not intended to limit the technical spirit of the present disclosure but to describe the present disclosure, and the scope of the technical spirit of the present disclosure is not limited by the example embodiments. The scope of protection of the present disclosure should be interpreted by the following claims, and all technical ideas that fall within the scope of equivalents thereof should be construed as being included in the scope of the present disclosure.

1. An electric mobility apparatus comprising:
a steering assembly comprising a handlebar manipulated by a user and a support shaft having one side coupled to the handlebar;
a mid-frame assembly comprising a user boarding part formed on an upper end;
a front frame assembly having one side coupled to the support shaft and the other side on which a first connector having at least a portion fastened to one side of the mid-frame assembly is formed; and
a tail frame assembly comprising a second connector of which at least a portion is fastened to the other side of the mid-frame assembly.

2. The electric mobility apparatus of claim 1, wherein the tail frame assembly comprises a tail frame and a rear wheel frame, and
the rear wheel frame comprises:
two wheel arms formed to face each other;
a first cut portion formed by cutting the wheel arm to seat a rear wheel shaft therein;
a bridge configured to connect the two wheel arms; and
an extension fastener formed to extend toward the other side of the wheel arm and inserted into the mid-frame assembly.

3. The electric mobility apparatus of claim 1, wherein the tail frame assembly comprises a tail frame and a rear wheel frame,
the tail frame comprises at least one slit formed on an outer side of the second connector, and
an extension fastener of the rear wheel frame is inserted into the mid-frame assembly by passing through the slit.

4. The electric mobility apparatus of claim 1, wherein the tail frame assembly comprises a tail frame and a rear wheel frame, and
the tail frame comprises:
a planar portion configured to form a plane extending from a face formed on the upper end of the mid-frame assembly when coupled to the mid-frame assembly; and.
a bent portion formed to extend from the planar portion and bent in an upper-end direction; and

5. The electric mobility apparatus of claim 1, wherein the mid-frame assembly comprises a guide on both inner side faces in a longitudinal direction of the mid-frame assembly, the guide forming an insertion passage through which an extension fastener of the tail frame assembly is to be inserted.

6. The electric mobility apparatus of claim 5, wherein the mid-frame assembly further comprises at least one fastening groove formed on the guide to fasten the extension fastener.

7. The electric mobility apparatus of claim 5, wherein the mid-frame assembly further comprises:
a hole formed on at least one side face; and
a fastening groove formed on the guide to fasten a support stand at a position corresponding to the hole,

8. The electric mobility apparatus of claim 1, wherein the tail frame assembly comprises a tail frame and a rear wheel frame, and
the tail frame further comprises a side-face guide configured to externally cover at least a portion of each of two wheel arms formed in the rear wheel frame.

9. The electric mobility apparatus of claim 1, wherein at least one of a battery and an inverter is mounted in the mid-frame assembly, and
the battery and the inverter are disposed to be spaced apart from each other.

10. The electric mobility apparatus of claim 1, wherein at least one fastening groove configured to fasten the first connector and the second connector is formed on at least one of the upper end and a lower end of the mid-frame assembly.

11. The electric mobility apparatus of claim 1, wherein the front frame assembly further comprises:
a planar portion configured to form a plane extending from a face formed on the upper end of the mid-frame assembly when coupled to the mid-frame assembly;
a bent portion formed to extend from the planar portion and bent toward the handlebar; and
a fastener formed to extend from the bent portion and fastened to the steering assembly, and
an angle between the fastener and an upper end of the first connector is 90 degrees (°) or more.

12. The electric mobility apparatus of claim 11, wherein the front frame assembly further comprises a sealing groove formed on a side opposite to a side in which the first connector is inserted into the mid-frame assembly.

13. The electric mobility apparatus of claim 1, wherein the front frame assembly is formed using a die casting method, and
the mid-frame assembly is formed using an extrusion method.

14. The electric mobility apparatus of claim 1, wherein the tail frame assembly comprises a tail frame formed using a plastic injection method and a rear wheel frame formed using a pressing method.

15. The electric mobility apparatus of claim 1, wherein the front frame assembly and the mid-frame assembly are formed of a metal material,
the tail frame assembly comprises a tail frame and a rear wheel frame,
the tail frame is formed of a plastic material, and
the rear wheel frame is formed of a steel material.
